(19) United States
(12) Patent Application Publication
(10) Pub. No.: US 2006/0235774 A1
(43) Pub. Date: Oct. 19, 2006

(54) System and method for collecting operational loss data for managing operational risk

(76) Inventors: Richard L. Campbell, Clemmons, NC (US); Mary D. Harris, Lewisville, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/095,892

(22) Filed: Mar. 31, 2005

(51) Int. Cl. G07B 17/00

(52) U.S. Cl. 705/30

(57) ABSTRACT

A computer-based system and method, computer readable medium comprising software and a data structure for associating general ledger transactions representing operational losses with operational loss information, such as an operational loss event.

### CROSS REFERENCE TO RELATED APPLICATION

This application is related to U.S. application Ser. No. ______, entitled System and Method For Creating Risk Profiles For Use In Managing Operational Risk, which is being filed simultaneously herewith, the contents of which are incorporated herein by reference.

A portion of this disclosure contains material that is subject to copyright protection. The copyright owner consents to the reproduction of the disclosure, as it appears in the Patent and Trademark Office patent files or records, but otherwise reserves all copyright rights whatsoever.

### FIELD OF THE INVENTION

The present invention generally relates to a computer-based system and method, and a computer readable medium containing computer software, for collecting operational loss data for use in managing operational risk. More particularly, the present invention relates to a computer-based system and method, and a computer readable medium containing computer software for associating general ledger transactions with operational loss information, including operational loss events.

### BACKGROUND OF THE INVENTION

Operational risk may be thought of as the risk of loss resulting from inadequate or failed internal processes, people, systems, or from external events. Operational risk may include legal risk, but typically excludes credit risk, business (or strategic) risk and reputation risk. Credit risk can be thought of as the risk to earnings or capital arising from an obligor's failure to meet the terms of any contract with a business enterprise, such as a financial institution, or otherwise failure to perform as agreed. Credit risk may be present in business activities where the outcome depends on another party's performance. Market risk, however, may be thought of as the risk of value deterioration and/or losses in an enterprise's on-and off-balance sheet positions due to adverse market moves against its holdings. Consequences of market risk may include diminished liquidity and financial losses. Finally, business risk (or strategic risk) may be thought of as potential losses a business unit may incur that is not a credit, market or operational risk. An example of a strategic risk may be a loss resulting from a flawed business model or a changing economic environment.

Typically, market or credit risk losses that include an operational loss component will not be categorized as operational risk losses for regulatory capital allocation purposes. Nevertheless, business enterprises may desire to track such losses meeting a predefined materiality threshold in an operational loss database. Such loss data may be segregated, however, from losses used for operational risk capital allocation purposes.

As can be appreciated, management of operational risk makes good business sense and gives a business enterprise competitive advantages, such as improved operational sophistication, speed and execution, improved customer experience, regulatory compliance, increased profits, the ability to invest excess capital, lower borrowing costs, reduced earnings volatility, higher valuation, and increased shareholder value. In addition, effective operational risk management of a financial institution may facilitate compliance with evolving regulatory requirements regarding operational risk, thereby allowing the financial institution to allocate lower levels of operational risk capital.

Therefore, what is needed is an operational risk management framework that provides a consistent and comprehensive operational risk management approach across a business enterprise, such as a financial institution. More particularly, what is needed is a system and method for collecting operational loss information. Even more particularly, what is needed is a comprehensive and complete system and method for associating general ledger transactions representing operational losses with operational loss information, such as operational loss events.

### BRIEF DESCRIPTION OF THE DRAWINGS

FIG. 1A illustrates an exemplary embodiment of the system of the present invention.

FIG. 1B illustrates an exemplary a system for collecting operational loss data.

FIG. 2A illustrates an exemplary process for collecting general ledger transactions representing operational losses and associating the transactions with operational loss events.

FIG. 2B illustrates an exemplary user interface to a process for searching for general ledger transactions to be uploaded to a Mapping process.

FIGS. 3A and 3B illustrate an exemplary user interface to a process for associating transactions representing operational losses with operational loss events.

FIG. 4A-4D illustrate an exemplary user interface to a process for creating an operational loss event.

FIGS. 5A-5E illustrate exemplary operational loss event types.

FIGS. 6A and 6B illustrate an exemplary user interface to a process for searching for an operational loss event.

FIG. 7 illustrates an exemplary data structure for storing transactions representing operational losses in association with operational loss events.

FIGS. 8A-8C illustrate an exemplary file format for the data structure illustrated by FIG. 7.

### DETAILED DESCRIPTION OF PREFERRED EMBODIMENTS

Reference will now be made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

Also, as can be appreciated, the processing logic of the invention can be implemented with either software or hardware, or a combination of the two. That is, the specification provides sufficient information to those skilled in the art to implement the invention using one or more general purpose computers programmed with software, and/or one or more specialized devices using discrete circuitry.

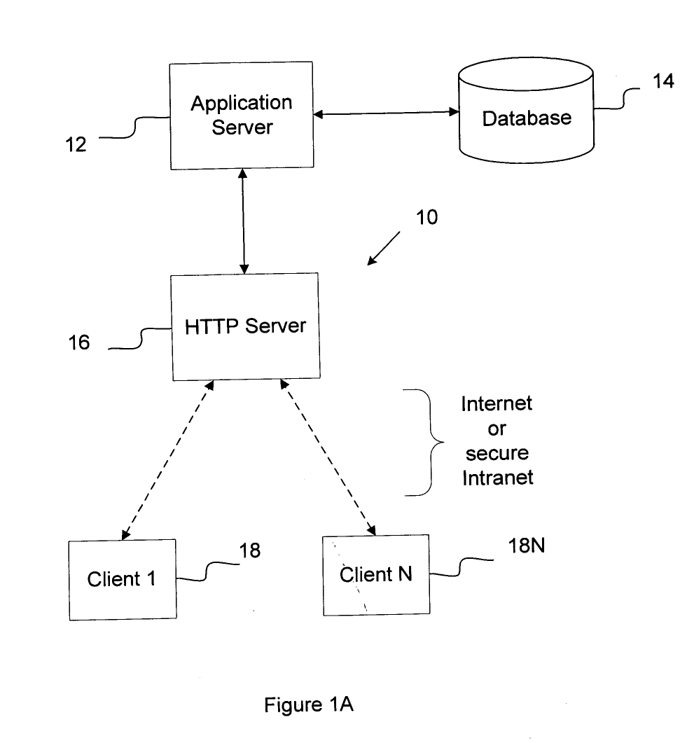

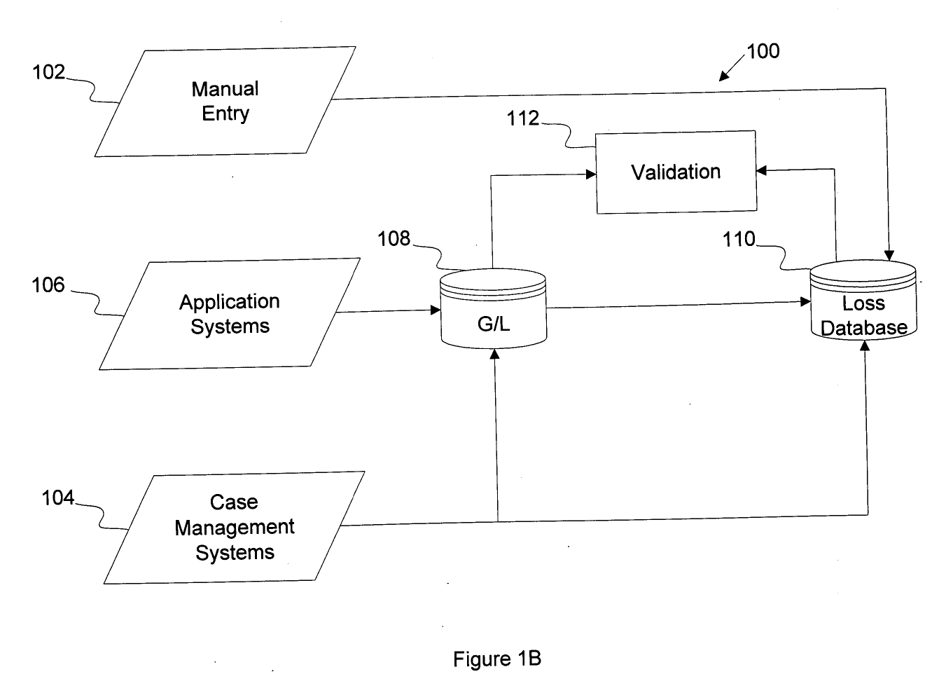

FIG. 1A illustrates an exemplary embodiment of the system 10 of the present invention. The exemplary embodiment described is a client-server web application that uses HTTP as its transport protocol. Multiple remote clients can access the system via a web browser. The system can authenticate users and encrypt data via secure sockets or VPN tunnels, for example. While a client-server web application is one embodiment of the invention, as those skilled in the art can appreciate, the invention is not limited to the use of client-server architecture, and other software architectures are within the scope of the present invention.

The system 10 includes the following components: an application server 12, a database 14, an HTTP server 16, and one or more clients 18-18N in electronic communication with the HTTP server 16 via an open communications network such as the Internet, or via a secure intranet.

Overview of Operational Risk Management

As an overview, collecting and categorizing operational loss data may be an initial step in a comprehensive operational risk management framework. Categorizing operational loss data may include associating operational loss data with one or more operational loss events. After operational loss data is collected and categorized, the operational loss information may be used to assess a business unit's operational risks and risk controls. Such an assessment, in turn, may be used to develop a risk profile for a business unit, which may include an assessment of a business unit's current risk control environment and its residual, i.e., future, risks. The process of developing a risk profile for a business unit, for example, may involve both analyzing past events and considering future operational risks so as to fully appreciate its operational risk management strengths and weaknesses. A risk profile may be used to establish actions to improve the management of a business unit's operational risk. In addition, a risk profile may be used in determining the amount of operational risk capital to be allocated to a business unit to comply with regulatory requirements, such as those imposed on a bank, for example. Operational loss information also may be used to generate reports for operational risk management personnel.

An effective operational risk management framework may be implemented using a computer-based operational risk information and management system. One suitable system is available from Centerprise Services, Inc. of Purchase, N.Y. As can be appreciated, however, other operational risk information and management systems may be used without departing from the scope and spirit of the invention. Functions that may be performed by operational risk information and management systems may include loss data collection and categorization, control self-assessments, risk profiling, and issue/action plan management. The present invention is directed to loss data collection and categorization.

Overview of Loss Data Collection

An operational loss may be defined as the financial impact associated with an operational event that may be recorded on an enterprise's financial statements consistent with generally accepted accounting principles (“GAAP”). Operational losses may include out-of-pocket expenses related to the loss event, while opportunity costs, foregone revenue, or costs of investments made to prevent subsequent losses may be excluded from the definition of an operational loss.

As discussed in more detail below, operational loss event information may be quantitative and qualitative information that describes an operational loss event, including, for example, the date of the loss, the value of the loss, the location of the loss, and control failures that led to the occurrence of the loss.

An effective loss data collection process can improve an enterprise's ability to manage operational risk by creating a database of quantitative and qualitative loss information. Such a database may facilitate the analysis of the cause(s) of operational loss events, which can inform operational risk management decisions, and provide input into the operational risk capital allocation process of an enterprise, such as a financial institution, i.e., a bank. The collection of detailed and comprehensive loss information is also a prerequisite for certification for the Advanced Management Approach under the Bank of International Settlements' new Capital Accord.

An effective operational loss data collection process will be comprehensive, enterprise-wide, and provide of a level of detail suitable to support management, reporting, and regulatory requirements. This may entail collecting, or capturing, all operational risk losses and storing such loss information in a loss database. It may be desirable to specifically identify and associate operational losses of a value equal to or over a predetermined threshold, e.g., $10,000, with standardized loss event types or categories, and to store such losses in association with such loss event types or categories in a loss database.

Preferably, an operational loss should be associated with a loss event and stored in the loss database when its financial impact is recorded on an enterprise's financial statements. It may be desirable to verify the financial integrity or completeness of a loss database by regularly reconciling it with the enterprise's general ledger. A general ledger also may have codes for a number of loss event types.

Losses that have characteristics of credit or market risk may be collected in the loss database but specifically identified as such for capital calculation purposes. An enterprise may track such losses for operational risk management purposes based on a predefined materiality threshold, e.g., $500,000.

In addition, an enterprise may track “near misses,” i.e., operational risk events that did not result in a direct or an indirect operational loss, such as detecting fraud prior to completing a transaction or catching an error before it becomes a financial problem for the enterprise. Such “near miss” information may be used in connection with risk and control assessment activities to assist the enterprise to better anticipate future loss scenarios. Such “near miss” information, however, would not be used as an input for calculating and allocating operational risk capital.

The categorizing and importing of loss data into the loss database may occur at a predetermined time, e.g., the 10th business day of a month for the preceding month. The process may include access right management functionality, which is well known in the art and would restrict access to the loss database to authorized personnel.

Generally, losses may be categorized in at least three ways. First, losses may be associated with loss event types or categories. Loss event types, particularly, for financial institutions, may be those defined by the Basel Accord, which defines capital requirements, including operational risk capital requirements, for banks. Loss event types and categories will be discussed in more detail below. Second, losses may be categorized by associating the loss with a functional risk areas, which are also discussed in more detail below. Finally, losses may be categorized by associating a loss with a business unit, which is also discussed in more detail below.

A loss data collection process may be thought of as having five stages. A first stage may be establishing and maintaining a loss data infrastructure. Operational risk management personnel define operational losses and establishes processes and procedures for collecting loss data across an enterprise. A second stage may be loss data collection and categorization of loss data, which will be discussed in more detail below. A third stage may be loss data validation and transmittal to and storage in a loss database. Loss data events, categorizations and descriptions may be reviewed by the relevant business unit management personnel to ensure overall data consistency and integrity before categorized loss data is transmitted to, and stored in, a loss database. Loss data also may be validated against an enterprise's general ledger. Categorized loss data may be posted to a loss database at a predetermined time, e.g., the 10^{th} business day of the month for the preceding month. Loss data validation will be discussed in more detail below. A fourth stage may be reporting the loss data. Loss data may be reported via standard reports, recurring customized database queries, and ad hoc queries. A final stage may be independent testing and verification of stored loss database so as to ensure the integrity of operational loss information stored in a loss database.

Collection of Loss Data

The collection of operational loss data facilitates the management of operational risk in an enterprise. FIG. 1B illustrates an exemplary system 100 for collecting operational loss data for operational risk management. As can be appreciated, and as illustrated by FIG. 1B, operational loss data may be found throughout an enterprise. Specifically, loss data may be captured manually 102, from case management systems 104, or from application systems 106, which may include loss data stored in a general ledger database 400. Each of these capture methods will be discussed in more detail below.

Loss Data Collected Manually

While most loss data will be collected via a case management system or an application system such as a general ledger system, loss data that has not been entered into a predefined (non-credit) loss account can be entered manually. To enter loss data manually, a create new event process may be provided. An exemplary create new event process will be discussed in greater detail below. As can be appreciated, the system and method of the present invention provides for user authentication and authorization to enter loss data for a particular organization and/or business unit. After such authentication and authorization, a user may enter both financial and non-financial information regarding an operational loss and a loss event, which also will be discussed in more detail below. The loss information required for creation of the loss event may vary depending upon the loss event category and the amount of the loss. The information entered by a user may be verified and a loss event may be created and stored in a loss database 110.

Loss Data Collected from Case Management Systems

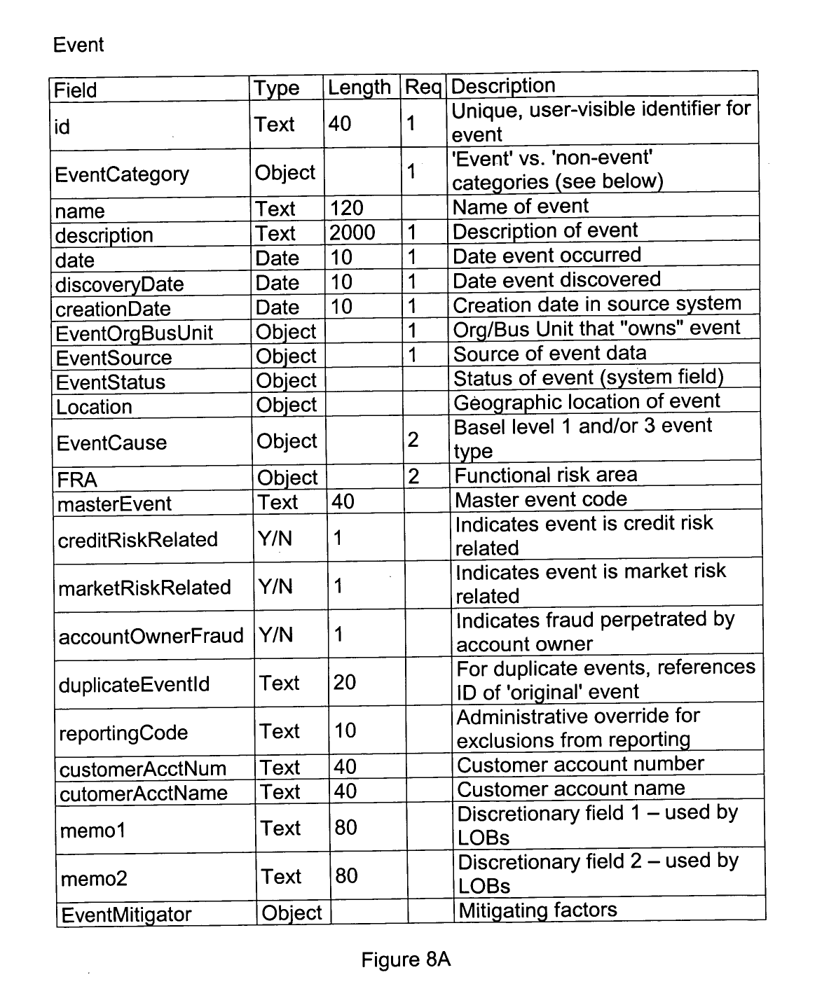

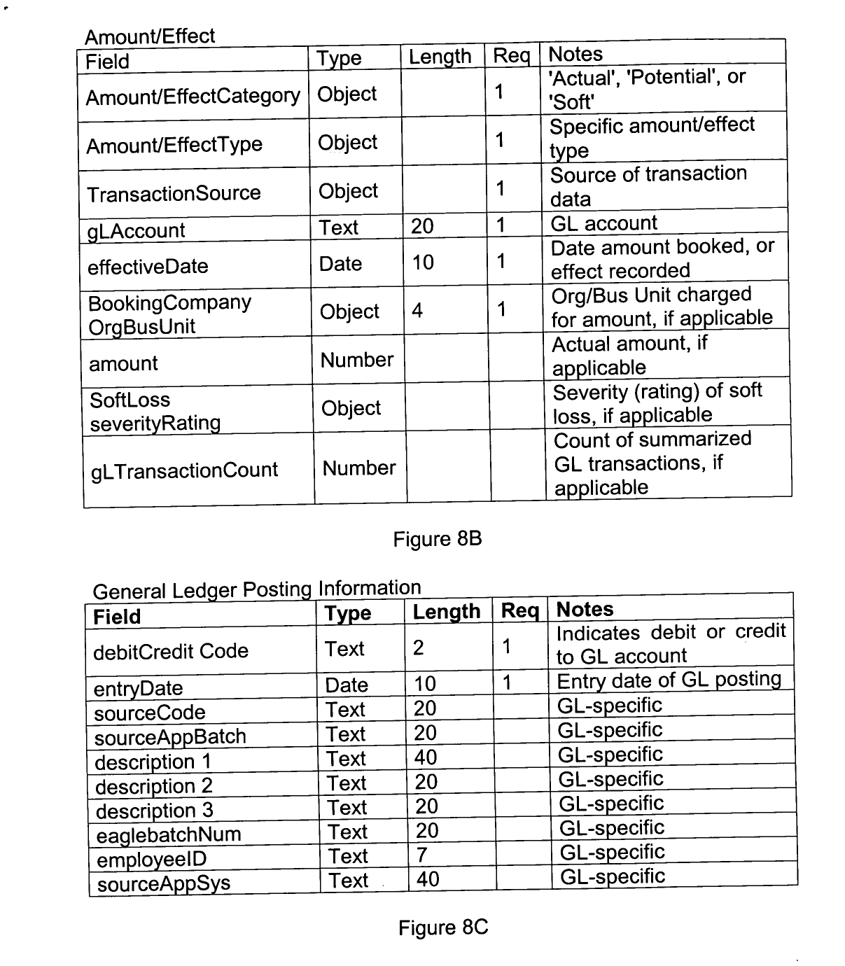

Loss data collected from case management systems 104 may be in a file format that is recognized by an operational loss database 110. An exemplary file format is illustrated in FIGS. 8A-8C. Transactions from case management systems 104 may be aggregated, for example, by organization, business unit, account number or month end date if such transactions are not already associated with an operational loss event or a batch of operational loss events. Approval of a loss event may be required if the aggregate loss is greater than or equal to an approval threshold. Examples of case management systems 104 from which loss data may be collected include case management systems for tracking fraud, legal claims, insurance claims, workers compensation claims, bank teller short and over accounts, ban adjustments, and other systems for tracking losses incurred by an enterprise.

Loss Data Collected from Application Systems

As mentioned above, loss data also can be collected from application systems 106, including transactions stored in a general ledger system 108. Examples of application systems from which operational loss data may be collected include applications systems for the various business units and/or functional areas. In the case of a financial institution, such as a bank, such business units and functional areas may include wealth management, capital management, operational services, wholesale operations, general bank, corporate and investment banking, human resources, finance and technology.

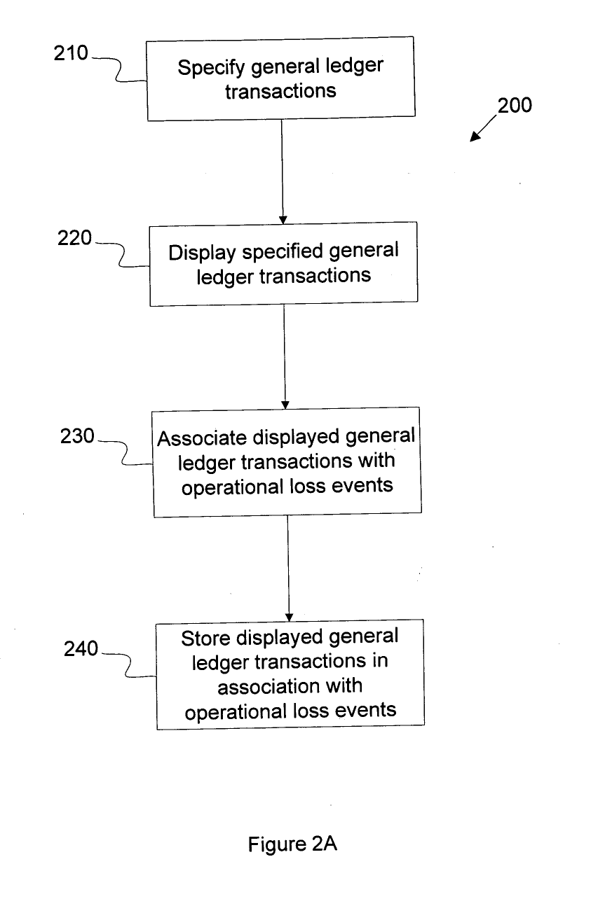

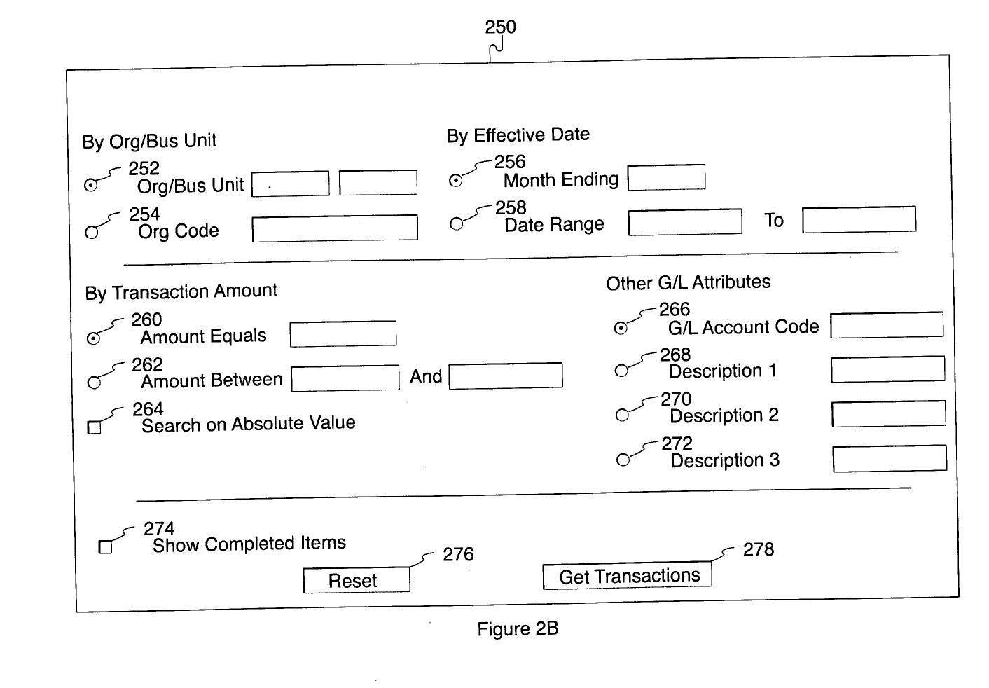

A process 200 for collecting general ledger transactions representing operational losses and mapping, or associating, the transactions with one or more operational loss events is illustrated in FIG. 2A. As shown in FIG. 2A, the process may begin with specifying one or more transactions that have been posted to a general ledger (block 210). Next, specified general ledger transactions may be displayed (block 220). Displayed transactions may be associated with operational loss information (block 230), including operational loss events. A user interface for displaying and associating displayed transactions with operational loss events will be discussed in more detail below. Displayed general ledger transactions may then be stored in association with associated operational loss event information (block 240). The transactions associated with operational loss event information may be validated prior to storage.

Categorization of Loss Data

A general ledger Mapping process may be provided to facilitate categorizing general ledger transactions, i.e., mapping (or associating) general ledger transactions with operational loss events. A Mapping process may be used to upload non-credit loss general ledger account information at predetermined intervals, e.g., monthly. General ledger transactions may be uploaded to the Mapping process based on specific general ledger account codes that are associated with operational losses. The Mapping process may exclude general ledger transactions that may have already been uploaded to the Mapping process via other case management systems or application systems. In addition, indirect losses, e.g., consultant fees, fees for temporary help, etc., soft losses, and potential losses, may not uploaded via the Mapping process, but may be uploaded and/or stored in a loss database via a manual entry process. The Mapping process may be configured to require that general ledger transactions representing losses above a predefined threshold, e.g., $10,000, be associated with an operational loss event.

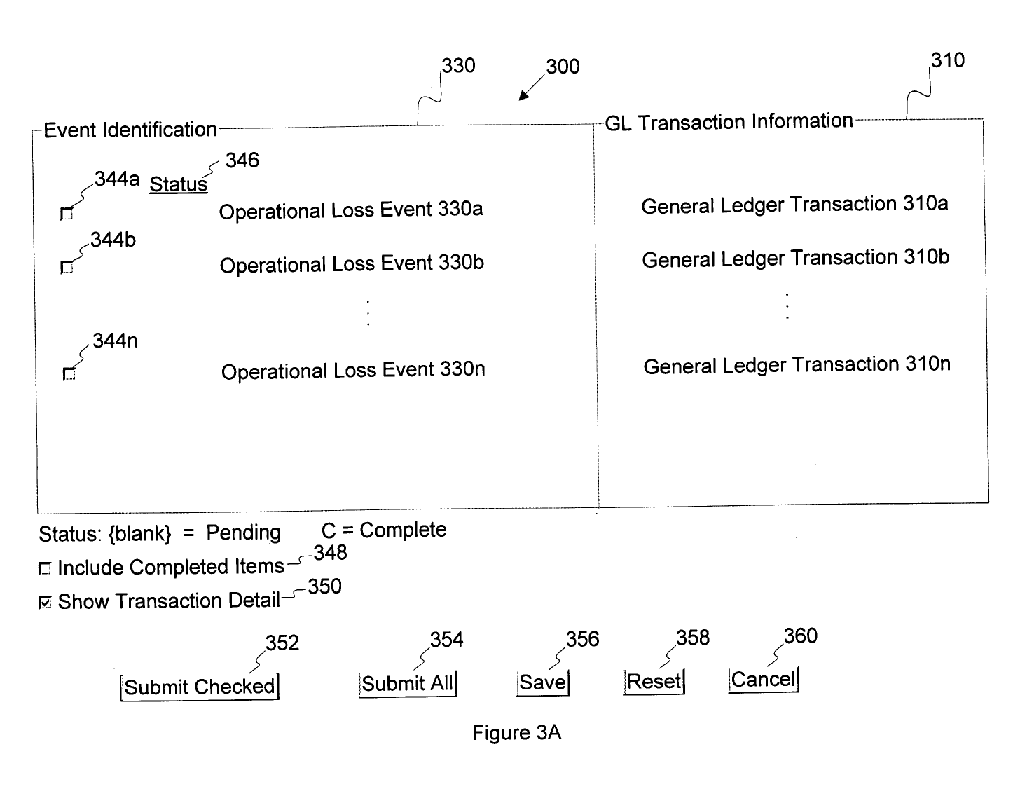

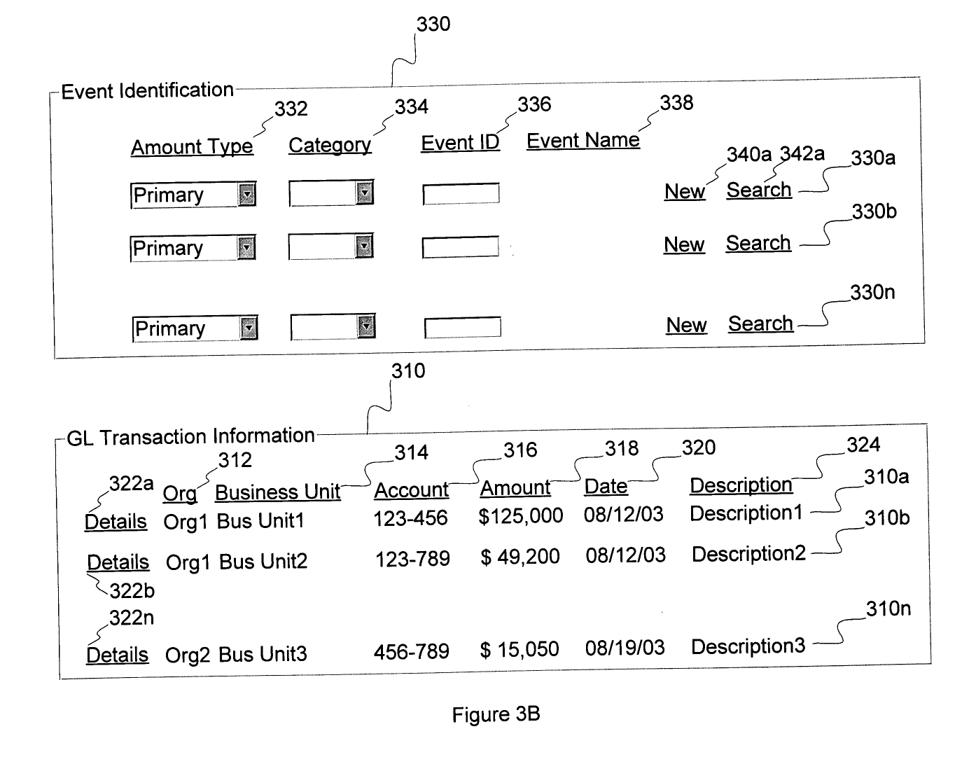

FIG. 2B illustrates an exemplary user interface 250 to a Search Transactions process for searching for general ledger transactions to be uploaded to a Mapping process. As can be seen in FIG. 2B, a transaction can be searched for by Org/Business Unit, by Effective Date, by Transaction Amount, or Other G/L Attributes. To search by an Organization/Business Unit an Org/Bus Unit 252 or Org Code 254 radio button may be selected and an appropriate value may be entered in field(s) associated with the selected radio button. The Search Transactions process may be configured to require the entry of an Org/Bus Unit value as a search parameter, with the remaining search parameters being optional. The Search Transactions process also may be configured to display an error message if a user does not have authorization to access transactions for the Org/Bus Unit or Org code entered. To search by Effective Date, a Month Ending 256 or a Date Range 258 radio button may be selected and appropriate value(s) may be entered in field(s) associated with the selected radio button. The Search Transactions process may be configured to display an error message if a user selects a Month Ending radio button 256 but does not enter the last calendar date of a month. To search by Transaction Amount, an Amount Equals 260 or an Amount Between 262 radio button may be selected and appropriate value(s) may be entered in field(s) associated with the selected radio button. A Search on Absolute Value checkbox 264 may be provided to search on an absolute value of a Transaction Amount. To search by Other G/L Attributes, a G/L Account Code 266, a Description 1 268, a Description 2 270 and a Description 3 272 radio button may be selected and appropriate value(s) may be entered in field(s) associated with the selected radio button. A Show completed items checkbox 274 may be provided to search for both completed and uncompleted items. The information entered into the Search Transactions interface 250 may be reset by selecting a Reset Button 276. To search for transactions based on the parameters entered via the Search Events interface 250, a Search Transactions button 278 may be selected. Selecting the Search Transactions button 278, may cause the specified transactions to be displayed via interface 300, which is illustrated by FIG. 3A.

A loss data control table may be provided, whereby one or more general ledger transactions are specified for uploading to a mapping process by reference to the loss data control table. A exemplary loss data control table is set forth below.

| | Event | Event | | Extended | Issue |
|---|---|---|---|---|---|
| Business | Delivery | Identification | Approval | Data | Creation |
| Unit | Method | Threshold | Threshold | Threshold | Threshold |
| Bus Unit 1 | Manual | | | | |
| Bus Unit 2 | Import | $5,000 | $5,000 | $5,000 | |
| Bus Unit 3 | Assistant | $1,000 | | | |
| Bus Unit 4 | Assistant | $500 | $50,000 | | $250,000 |

FIG. 3A illustrates an exemplary user interface 300 for categorizing general ledger transactions via a Mapping process. As can be seen from FIG. 3A, the interface provides an area 310 for displaying information about specified general ledger transactions 310a, 310b . . . 310n, and an area 330, wherein operational loss events 330a, 330b . . . 330n may be mapped to, or associated with, each of the displayed general ledger transactions 310a, 310b . . . 310n. The process of associating operational loss events with general ledger transactions will be discussed in more detail below.

FIG. 3B illustrates the information contained in the general ledger transaction information area 310 and the loss event information area 330 in more detail. As can be seen from FIG. 3B, a general ledger transaction information area 310 includes the following fields of information about general ledger transactions 310a, 310b . . . 310n that have been uploaded to the Mapping process: Org (Organization) 312, Business Unit 314, Account 316, Amount 318, Date 320 and Description 324. A Details link 322a, 322b . . . 322n may be provided for and correspond with each displayed general ledger transactions 310a, 310b . . . 310n, which, when selected, will cause the Mapping process to display more detailed information about the corresponding general ledger transaction 310a, 310b . . . 310n.

As also can be seen from FIG. 3B, a loss event information area 330 includes details about loss events 330a, 330b . . . 330n that are associated with the corresponding general ledger transactions 310a, 310b . . . 310n, which are displayed in the general ledger transaction information area 310.

For each event displayed in area 330, an Amount Type field 332 may be populated with a value via a drop down box. Values that may be entered in an Amount Type field depend on an Amount Category for the loss. Amount Categories may be Actual Amount, Potential Amount and Soft Loss. Amount Categories will be discussed in more detail below. Values that may be entered in the Amount Type field for an Actual Amount may include: Primary Loss/Gain, which includes direct losses or gains associated with an event, such as, a principal amount, a customer loss, a settlement, a penalty, etc.; External Legal Costs, which may include external legal costs associated with an event including, attorneys fees, court costs, accountants fees, consultant fees and investigative fees; Cost Recovery, which includes an insurance recovery, which may be amounts contributed by an insurance company, or paid directly to a plaintiff or client of an enterprise, a customer recovery, a settlement, a judgment, a cost recovery or a fraud recovery; Other External Costs, which may be other external costs including accountants, consultants, investigators, etc; Other Recovery, which may include all amounts recovered outside of insurance; Timing, which may be temporary misbookings that persist over year-end and temporarily affect profit and loss; and Unposted Loss, which may be used to identify future waived fees. The Mapping process may be configured so that the Amount Type value defaults to Primary Loss/Gain.

For each transaction displayed in area 330, a loss event Category field 334 may be populated with a value via a drop down box. Values that may appear in the Category field include: Event, which may be an operational loss event that meets predefined operational risk threshold; Batch, which may be an event containing a single transaction that exceeds a predefined operational risk threshold for event identification, but does not represent a single event; batch events may comprise multiple events that are posted to a general ledger in a single entry; Correction, which may be an event containing a single transaction, over a predefined operational risk threshold and that may be the result of a correction in a general ledger; Reclass, which may be a transaction over a predefined operational risk threshold and that may be the result of a reclassification in a general ledger; and NonOpLoss, which may be a non-operational loss event. Summary is a value that may be assigned to a loss event Category field. A Summary event may be thought of as an event containing a summary of transactions for a given organization/business unit/account combination, for a predetermined time period, e.g., a month, that do not meet a predefined threshold that requires that a transaction be associated with an event.

In order to associate a general ledger transaction displayed in area 310 with an operational loss event in area 330, a corresponding Event ID field 336 may be populated. For example, to associate transaction 310a with event 330a, an Event ID field 336 for event 330a may be populated. When a value is entered in Event ID field 336, an event name associated with an Event ID may be displayed in an Event Name field 338. An Event ID field may be populated by (1) manually entering an Event ID value for a preexisting event for which an Event ID value is known, (2) by creating a new event by selecting a New link 340a for event 330a, (3) by searching for a preexisting event for which an Event ID value is not known by selecting a Search link 342a for event 330a.

Enter New Event Process

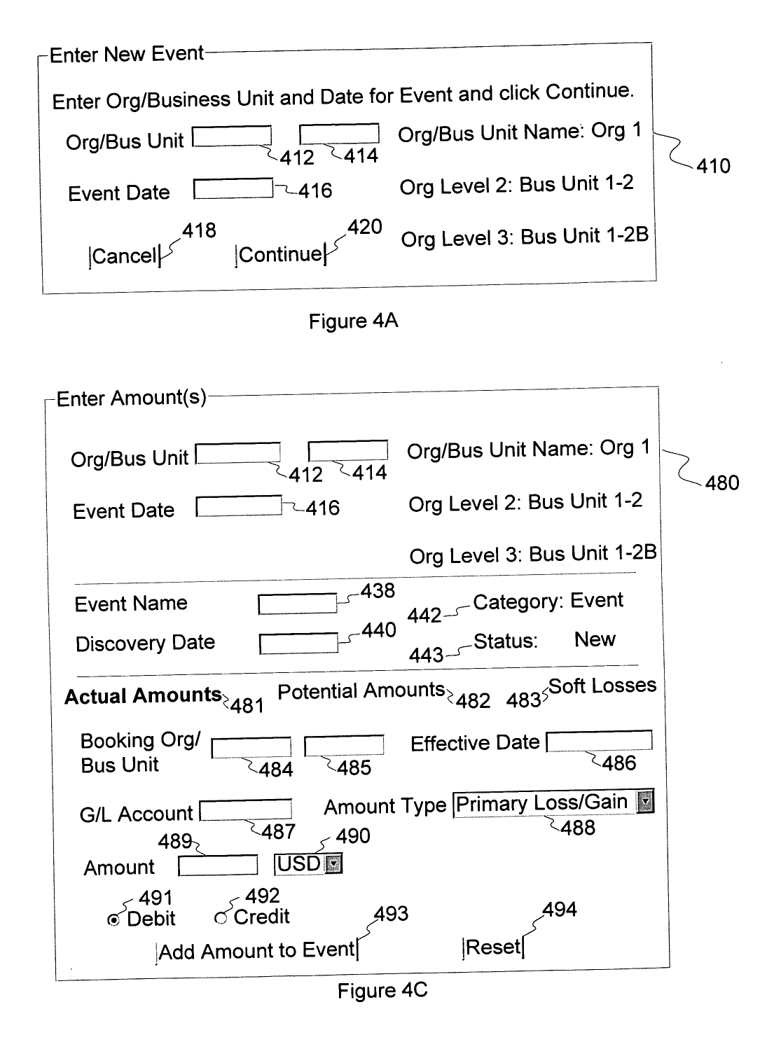

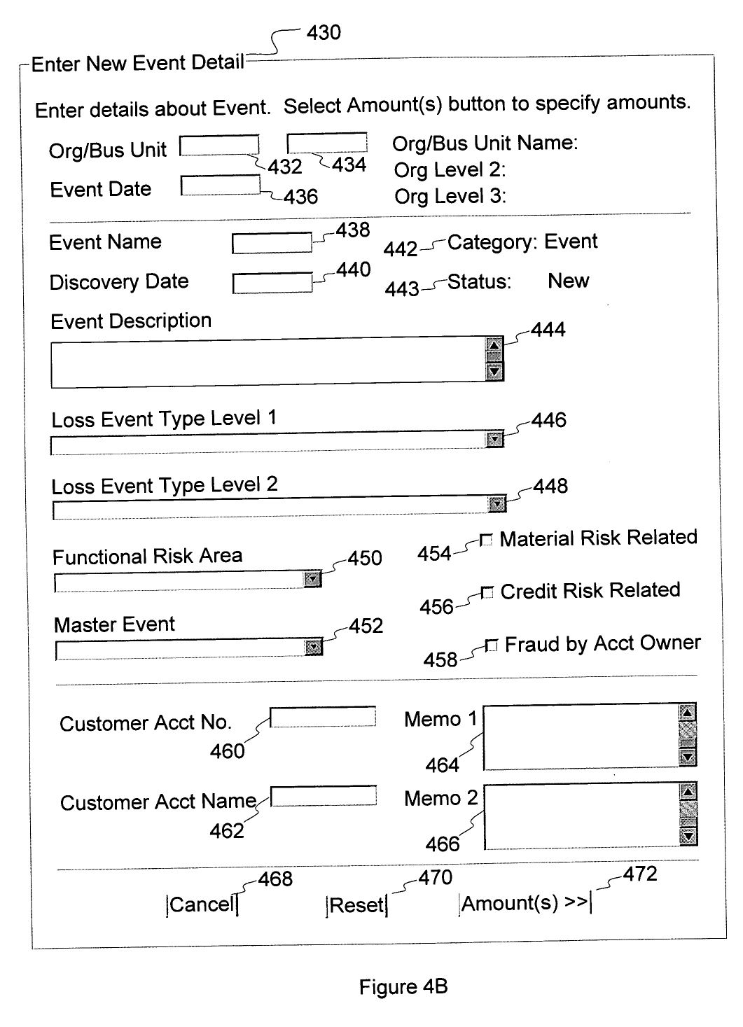

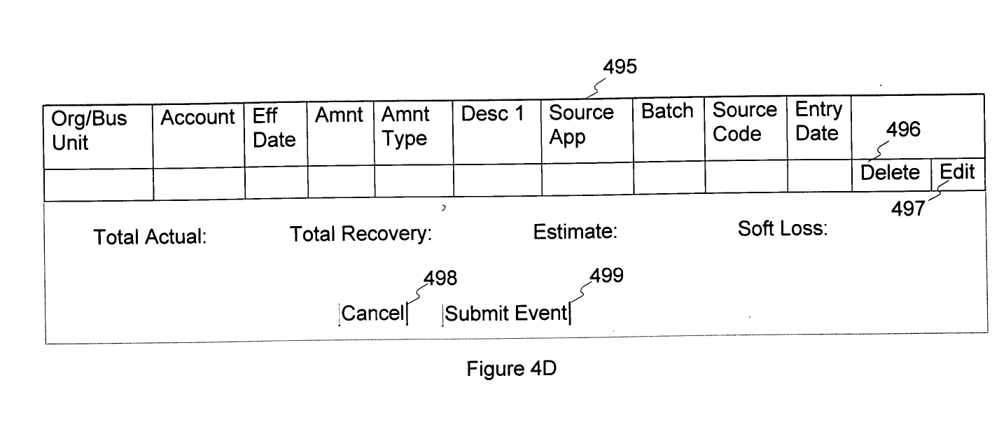

Continuing with the example, if an operational loss event 330a to be associated with general ledger transaction 310a has not been created, it may be created by selecting the New (Event) link 340a. Selecting New (Event) link 340a, will initiate an Enter New Event process, which will cause an Enter New Event screen 410 to be displayed, which is illustrated in FIG. 4A. As can be seen from FIG. 4A, an Enter New Event screen allows for entry of values for an Organization (Org) 412, Business Unit 414 and Event Date 418 associated with an Event. An Organization/Business Unit entered may be an Organization/Business Unit in which an event actually occurred and may be used for capital allocation purposes. An Organization/Business Unit value entered may be different from an Organization/Business Unit to which the loss associated with the event is posted in a general ledger. The Enter New Event process can be cancelled by selecting the Cancel button 420 or continued by selecting the Continue button 422. Selecting the Continue button 422 will initiate an Enter New Event Detail process, which will cause an Enter New Event Detail 430 screen to be displayed, which is illustrated in FIG. 4B. Alternatively, selecting the Continue button may cause an Event Confirmation screen to be displayed whereby the information entered via an Enter New Event Screen 410 can be confirmed prior to displaying an Enter New Event Detail Screen 430.

As illustrated by FIG. 4B, an Enter New Event Detail Screen 430 may include Organization/Business Unit 432, 434 and Event Date 436 information entered via the Enter New Event screen 410. An Enter New Event Detail Screen 430 may also allow for entry of additional information to be associated with an event. This screen may be used to capture specific and required details on loss events that are greater than (or equal to) a predetermined threshold, e.g., $10,000. As can be seen from the Enter New Event Detail Screen 430, a name used to refer to an event may be entered into the Event Name field 438, and a date when the loss event was discovered (as opposed to when it occurred) may be entered into a Discovery Date field 440. A Discovery Date should not be earlier than the Event Date. A (operational loss) Category field 442 and a Status field 443 may be automatically populated with the values Event and New, respectively. A description of the event and circumstances related thereto may be entered in an Event Description field 444.

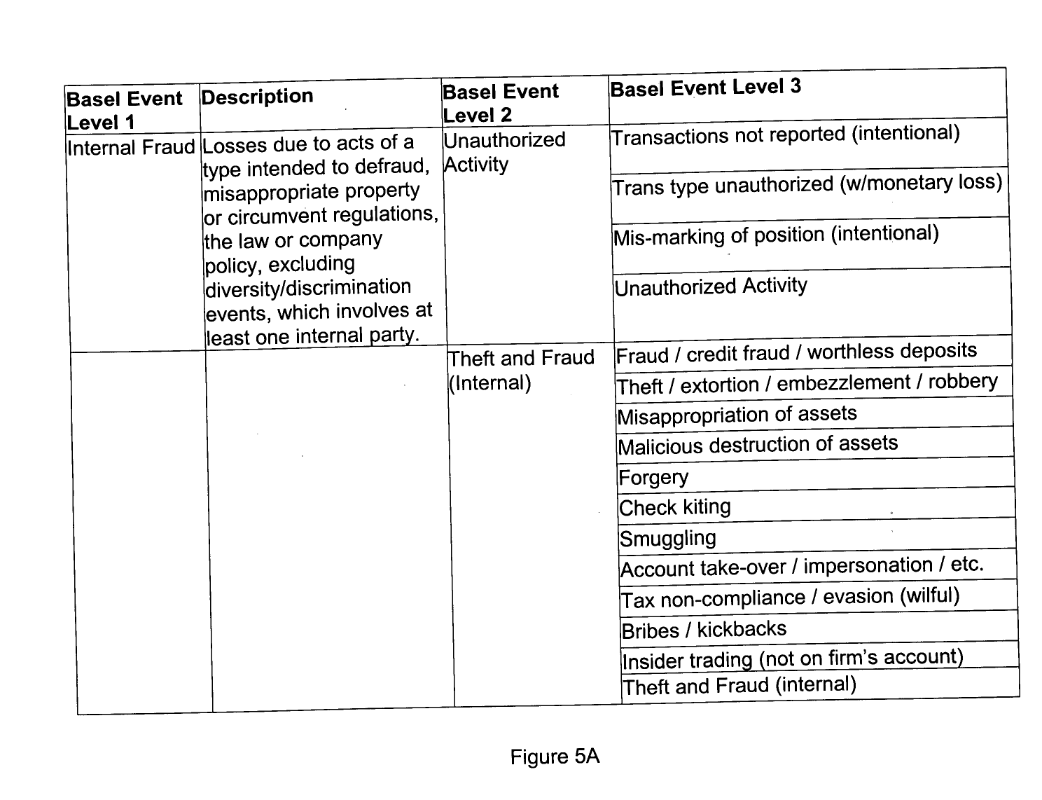

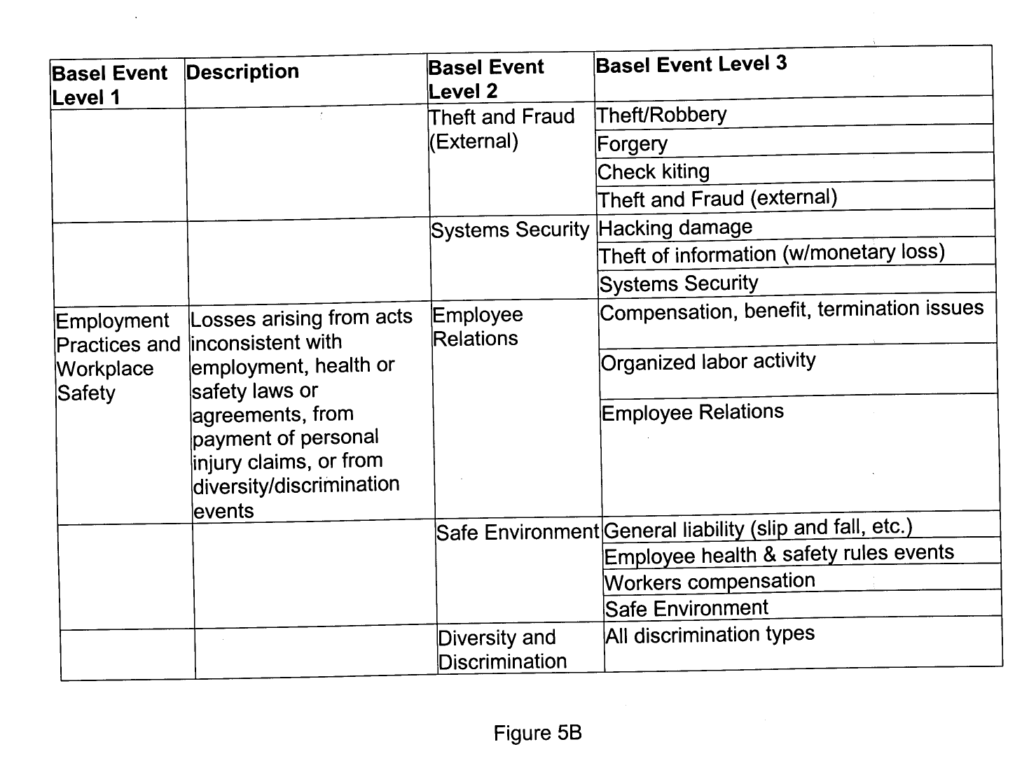

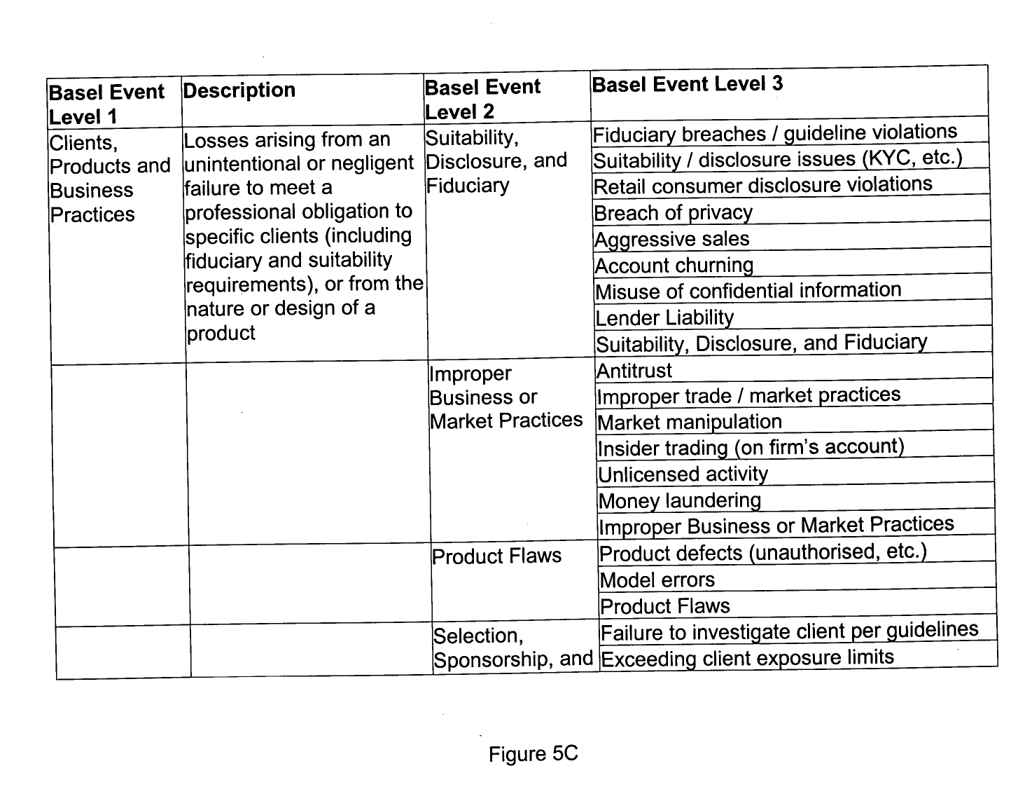

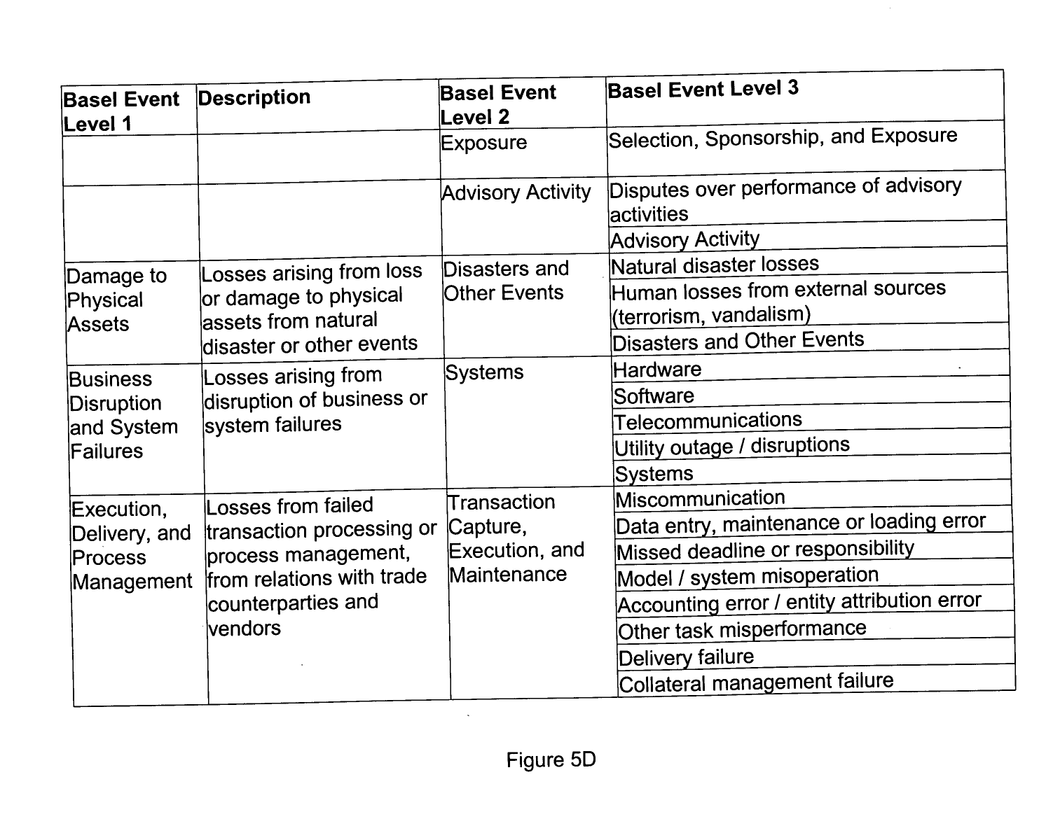

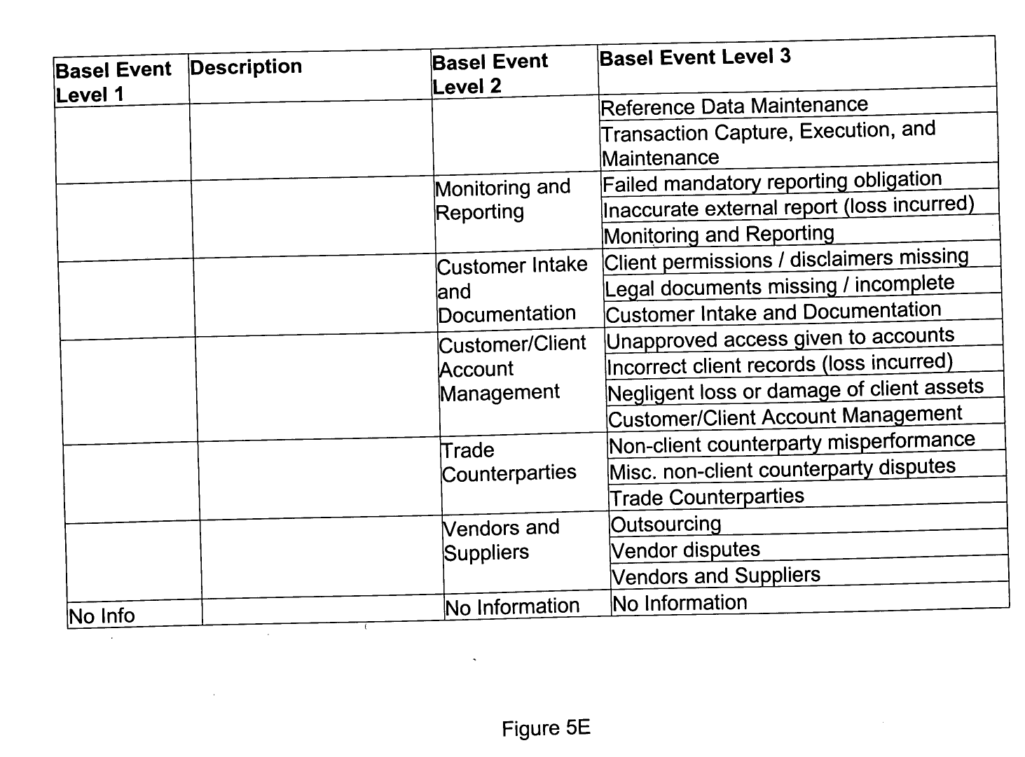

Continuing to refer to FIG. 4B, a loss event type may be entered into a Loss Event Type Level 1 field 446 via a drop down box. Valid values for the Loss Event Type Level 1 field 446 may include Basel Event Level 1 loss types as determined by the Basel Accord. A more specific loss event type may be entered into a Loss Event Type Level 2 field 448 via a drop down box. Valid values for the Loss Event Type Level 2 field 448 may include Basel Event Level 2 or Basel Event Level 3 loss types as determined by the Basel Accord. Basel Event loss types, including Basel Level 1, Level 2 and Level 3 loss types are set forth in FIGS. 5A-5E. The invention, however, is not limited to the use of Basel Event loss types and the use of other loss types is within the scope and spirit of the invention.

Returning to refer to FIG. 4B, a functional risk area may be entered into a Functional Risk Area field 450 via a drop down box. A functional risk area may be thought of as an operational function that has or may incur an operational loss. Functional risk areas may include Vendor, Technology, Business Continuity Planning, Implementation Risk Management, Loss Management, Fiduciary, Legal, Compliance, Financial, Human Capital, Business Process and Real Estate. A vendor risk may include losses from companies that perform functions on behalf of the enterprise, e.g., outsourced functions, that provide products and services to the enterprise and/or its customers, and that use the enterprise's trade names, trademarks or service marks, e.g., franchisees. A vendor functional risk may also include losses from a vendor's inability to perform under a contract or other agreement, to fail to maintain a system, or a failure of vendor supplied system. A technology risk may include losses from hardware, software, and telecommunications links that are used to store, receive, transmit, and recover information. It may also include losses from operational processes that manually or automatically move information and record customer's transactions, and hardware or software system processing mistakes. A business continuity planning risk may include losses from external or internal events affect processes or personnel resulting in partial or total interruption of normal business operations or services. Business continuity planning risk may also include losses from a loss of electrical power that results in an interruption of work or building damage due to natural disaster or terrorism. An implementation risk may include losses from implementation of major change events such as mergers, acquisitions, divestitures, conversions, new projects, new products or services, and organizational changes, such as a restructuring. Loss risk may include loss from internal and external fraud. Internal fraud may include unauthorized transactions, insider trading, kickbacks and embezzlement. External fraud may include theft, forgery, check kiting, hacking, and theft of information. Loss risk may also include any loss related to theft or robbery. Fiduciary risk may include losses from failing to fulfill fiduciary duties to customers, for example, and violations of trust fiduciary duties. Legal risk may include losses litigation and other legal matters. Legal risk may also include losses from errors in litigation. Compliance risk may include losses from failure to comply with applicable laws, rules, regulations, prescribed practices, or ethical standards. Financial risk includes losses from recording of financial transactions, processes, and internal and external financial reporting. Financial risk may also include losses related to accounting errors, reconcilement, and inaccurate reporting. A human capital risk may include losses from human resources including deficiencies in competencies, training, skills, performance, integrity or availability of employees. Human capital risk may also include losses from failure to comply with employment, health, and safety laws, or personal injury, discrimination or workers compensation claims. Business process risks may include losses from operational risks that are specific to a particular business unit or process, such as data entry, maintenance or loading error, delays, and missed deadlines. Real estate risk may include losses from breaches of physical security of employees, buildings, equipment or equipment, or claims by customers on the enterprise's premises, e.g., slip and fall claims. While some loss events have characteristics of more than one type risk, the loss should be included in only one capital calculation.

Continuing to refer to FIG. 4B, a master event may be entered into a Master Event field 452 via a drop down box. A master event may be thought of as an event that could have consequences throughout an enterprise. An example of a master event may be the terrorist attacks on Sep. 11, 2001.

If a loss event relates to a market or credit risk, a Market Risk Related checkbox 454 or a Credit Risk Related check box 456 may be selected. Similarly, if a loss event relates to a fraud perpetrated by an account owner, a Fraud by Owner checkbox 458 may be selected.

If a customer's account was impacted by a loss event, an applicable customer account number may be entered into a Customer Acct No. field 460 and a customer name may be entered into a Customer Name field 462. Additional information relating to a loss event may entered into a Memo 1 field 464 and/or a Memo 2 field 466. A Cancel button 468 may be selected to cancel the Enter New Event Detail process and to exit the Enter New Event Detail screen 430. A Reset button 470 may be selected to reset all of the fields of information in the New Event Detail screen 430. Finally, if required event information has been entered into the New Event detail screen 430, an Amounts button 472 may be selected, which will initiate an Enter Amount(s) process and which will cause an Enter Amount(s) screen 480 to be displayed, which is illustrated in FIG. 4C. The Enter Amount(s) process allows for entry of loss amounts for an event, which is described in more detail below.

As can be seen from FIG. 4C, an Enter Amount(s) screen 480 displays Organization/Business Unit 412, 414 and Event Date 416 information entered via the Enter New Event screen 410. The Enter Amount(s) screen 480 also allows displays the Event Name 438, Discovery Date 440, Category 442 and Status 443 information entered via the Enter New Event Detail Screen 430. The Enter Amount(s) screen 480 also provides for the entry of information about the loss, including amount and type of loss, to be associated with the event.

As also can be seen from FIG. 4C, one of three categories of loss amounts may be selected. An actual loss amount (in dollars) from a loss event to date may be posted to a general ledger by selecting an Actual Amounts link 481. The Enter Amount(s) screen 480 may be configured so that Actual Amounts is a default loss amount category. An estimated loss amount (in dollars) from a loss event that may be posted to a general ledger in the future may be entered by selecting a Potential Amount link 482. A loss amount from a loss event that cannot be quantified (in dollars) but that may be expected to have a negative impact on the enterprise, e.g., a reputational risk, may be entered by selecting a Soft Losses link 483.

The information to be entered via the Enter Amount(s) screen 480 may be transaction specific. In addition, every transaction should have amount information associated with it unless the transaction is a soft loss. Losses/gains entered via the Mapping process may not necessarily be classified as operational losses in a general ledger. Although there may be general ledger accounts designated as operational loss accounts, some losses may be posted to general ledger accounts that are not designated as operational loss accounts. Multiple loss/gain transactions for the same event may be linked or aggregated even if they affect more than one organization, business unit or accounting period.

The following fields of information about the loss may be entered via an Amount(s) Entry screen 480 if the Actual Amounts link 481 is selected, by default or otherwise. An Organization/Business Unit to which the loss is booked (“Booking Org/Bus Unit”) may be the same as or different from the Organization/Business Unit to which the loss event is related. A checkbox (not shown) may be provided, which may be checked if they are the same, in which case Booking Org/Bus Unit fields 484, 485 will be automatically populated with the information previously entered into the Organization/Business Unit fields 412, 414 via the Enter New Event Screen 410. If they are not the same, an Organization/Business Unit to which the loss is to be booked may be entered into the Booking Org/Bus Unit fields 484, 485. A date that a general ledger balance and other related calculations were affected by the loss may be entered into an Effective Date field 486. A general ledger account to which the loss is booked may be entered into a G/L Account field 487.

An amount type, which may identify a type of transaction, may be entered into an Amount Type field 488 via a drop down box. Amount types for Actual Amounts, which have been discussed in more detail above, may include a (Primary) Loss/Gain, an External Cost, a Cost Recovery, a Timing Loss, an Unposted Loss or an Estimate of a future loss. External costs may include attorneys fees, court costs, accountants fees, consultant fees and investigative fees. A Cost Recovery may include an insurance recovery, a customer recovery, a settlement, a judgment, a cost recovery and fraud recovery. When adding Actual Amounts, the default value for the Amount Type filed may be (Primary) Loss/Gain.

Continuing to refer to FIG. 4C, a dollar value of the loss may be entered into an Amount field 489. A currency may be selected from a Currency field 490 via a drop down box. A Debit radio button 497 or a Credit radio button 498 may be selected to indicate a type of impact on a general ledger. The Enter Amount(s) screen 480 may be configured to default to select the Debit radio button 497.

Upon entering the information related to an Actual Amount, an Add Amount to Event button 493 may be selected, in which case a message (not shown) may be displayed indicating that the actual amount(s) entered have been associated with an event. The Enter Amount(s) screen 480 may also be configured so that the amount information entered via the Enter Amount(s) screen may be validated when the Add Amount to Event button 493 is selected. If amount information cannot be validated because it has been entered incorrectly, for example, an error message (not shown) may appear when the Add Amount to Event button 493 is selected. The amount information entered via the Enter Amount(s) screen 480 may be reset by selecting a Reset button 494. Selecting an Add Amount to Event button 493 will cause a box 495 to be displayed, which is illustrated in FIG. 4D and which summarizes the information entered via the Enter Amount(s) screen 480. As can be seen from FIG. 4D, a transaction may be edited or deleting by selecting an Edit link 496 or a Delete link 497 that may be located beside the transaction to be edited. Information regarding a Total Actual loss, a Total Recovery, and/or a loss Estimate may be displayed and updated after an amount is added via Enter Amount(s) screen 480. The number of Soft Losses may also be displayed.

Returning to FIG. 4C, an estimated loss amount (in dollars) from a loss event that may be posted to a general ledger in the future may be entered by selecting a Potential Amount link 482. Selecting the Potential Amount link will cause the Enter Amount(s) screen 480 to be displayed, and Potential Amount information may be entered, edited, deleted, validated, displayed and submitted to a loss database in the same fashion as Actual Amount information, which is described in detail above. Information regarding Booking Organization/Business Unit, Effective Date, and G/L Account may not be required for Potential Amounts. When adding Potential Amounts, the default value for the Amount Type field may be Estimate.

Returning to FIG. 4C, a loss amount from a loss event that cannot be quantified (in dollars) but that is expected to have a negative impact on an enterprise, e.g., a reputational risk, may be entered by selecting a Soft Losses link 483. Selecting a Soft Losses link 483 will cause an Enter Amount(s) screen to be displayed, which may include an Impact Type field that may allow for an Impact Type value to be entered via a drop down box. Impact Types may include Customer, which can include events that have an impact on an enterprise's customers; Employee, which can include events that may have an impact on an enterprise's employees or their work environment, e.g., overtime, etc.; Hiring, which can include events that may have an impact on hiring; Reputation, which can include events that may have an impact on the reputation of the enterprise; and Training, which can include events that may have an impact on training of employees. Information may also be entered regarding the Severity of the impact of the soft loss, e.g., high, medium or low. In addition, a field may be provided for entry of a Comment about a soft loss. Soft Loss information may be edited, deleted, validated, displayed and submitted to a loss database in the same fashion as Actual Amount information, which is described in detail above.

Returning to FIG. 4C, the entry of an amount may be cancelled by selecting a Cancel button 498. After amounts associated with an event have been entered, the event and the information relating thereto may be submitted for storage in a loss database by selecting a Submit Event button 499. Amounts may not be edited or deleted after the event has been submitted. Selecting the Submit Event button 499 may cause a confirmation screen (not shown) to be displayed, which confirms that the event has been created and which summarizes the information associated with the event, including loss amount information. Selecting a Submit Event button 499 also may cause the event information be submitted to operational risk management personnel for review.

Search Events Process

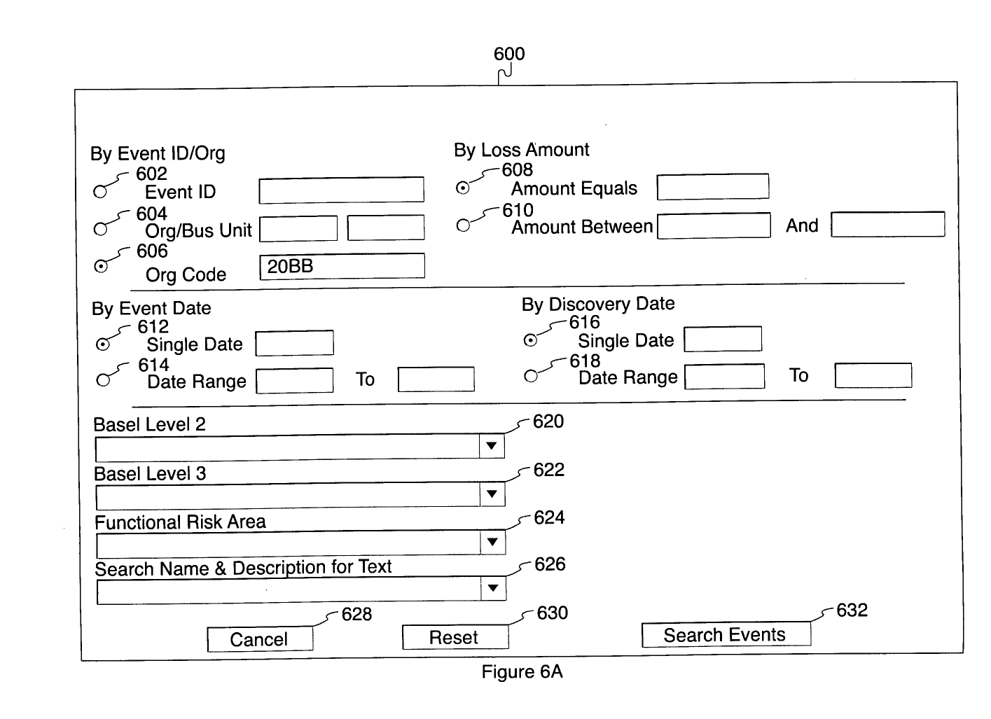

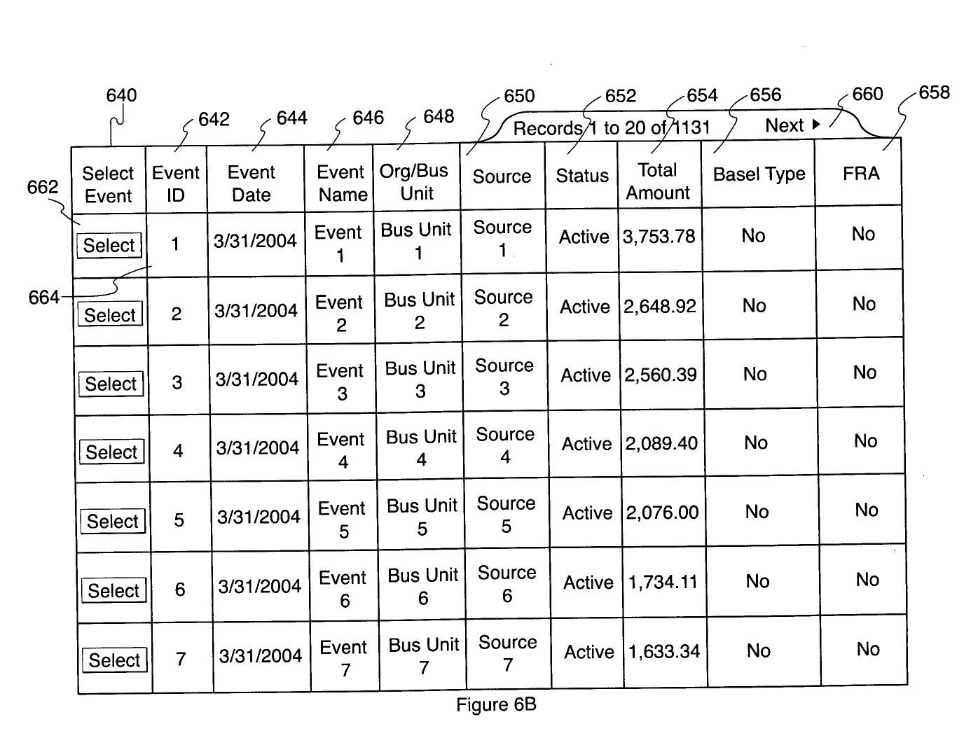

Returning to FIG. 3B, and continuing with the example, if the operational loss event 330a to be associated with a general ledger transaction 310a exists, but the Event ID is not known, an Event ID value may be searched for by selecting a Search link 342a for event 330a. Selecting the Search link 342a will initiate a Search Events process, which will cause a Search Events screen 600 to be displayed, which is illustrated in FIG. 6A. As can be seen from FIG. 6A, an event can be searched for by Event ID/Org, by Loss Amount, by Event Date or by Discovery Date. To search by Event ID/Org, a user can select an Event ID 602, Org/Bus Unit 604 or Org Code 606 radio button and enter an appropriate value in fields associated with the selected radio button. The Search Events process may be configured to require the entry of an Event ID/Org value as a search parameter, with the remaining search parameters being optional. To search by Loss Amount, an Amount Equals 608 or an Amount Between 610 radio button may be selected and appropriate value(s) may be entered in field(s) associated with the selected radio button. To search by Event Date, a Single Date 612 or a Date Range 614 radio button may be selected and appropriate value(s) may be entered in field(s) associated with the selected radio button. To search by Discovery Date, a Single Date 616 or a Date Range 618 radio button may be selected and appropriate value(s) may be entered in field(s) associated with the selected radio button. To search by a loss event type, a Basel Level 2 or a Basel Level 3 loss type may be selected via drop down boxes 620 or 622, respectively. To search by a functional risk area, a functional risk area may be selected via drop down box 624. To search a name and description, a value may be entered in a Search Name & Description for Text box 626. The Search Events process can be cancelled by selecting a Cancel button 628 or the information entered into the Search Events screen 600 may be reset by selecting a Reset Button 630. To search for preexisting events based on the parameters entered via the Search Events screen 600, a Search Events button 632 may be selected. Selecting the Search Events button 632 may cause a Search Results screen 640 to be displayed, which is illustrated by FIG. 6B.

As can be seen by FIG. 6B, a Search Results screen 640 may display detailed information about one or more events identified via the Search Events process, including, Event ID 642, Event Date 644, Event Name 646, Org/Bus Unit 648, Source 650, Status 652, Total Amount 654, Loss Type 656 and Functional Risk Area 658. If more events are identified via the Search Events process than may be displayed on a single screen, a Next link 660 may be selected which will cause additional events identified via the Search Events process to be displayed.

Continuing to refer to FIG. 6B, to associate a particular event displayed via the Search Results screen 640 with a general ledger transaction, a Select button 662, which corresponds to that event, may be selected, in which case that event will then be displayed in the loss event information area 330 (FIGS. 3A and 3B) in association with a corresponding general ledger transaction displayed in the general ledger transaction information area 310. Returning to FIG. 6B, The Event ID for a particular event may be configured as a link 664, which, when selected, will cause additional information about that event to be displayed via an Event Detail screen (not shown).

Returning to FIG. 3A, a Status field 346 may be provided for each of the displayed general ledger transactions 310a, 310b, . . . 310n, which indicates whether the process of associating the transactions 310a, 310b, . . . 310n with loss events has been completed. If the Status field for a particular transaction is blank, the process of associating an event with that transaction is pending and has not been completed. If the Status field for a particular transaction contains the value C, the Status of that transaction is Complete, which means that the process of associating an event with that transaction has been completed. A Include Completed Items check box 348 may also be provided, which, if selected, will cause the user interface 300 to the mapping process to display all transactions that have been associated with a loss event. A Show Transaction Detail check box 350 may also be provided, which, if selected, will cause the user interface 300 to the Mapping process to display details of the transactions 310a, 310b, . . . 310n displayed in the general ledger transaction information area 310.

After the general ledger transactions 310a, 310b, . . . 310n that are displayed in the general ledger transaction information area 310 have been associated with an operational loss events 330a, 330b, . . . 330n via the Mapping process, one or more of the transactions and associated events may be selected for further processing by selecting checkboxes 344a, 344b, . . . 3442n that are associated with transactions 310a, 310b, . . . 310n and events 330a, 330b, . . . 330n. The selected transactions, and the associated events, may be submitted to a validation process, which is described in more detail below, by selecting a Submit Checked button 352. Alternatively, all transactions, and the associated events, may be submitted to a validation process by selecting a Submit All button 354. Transactions that have been associated with an event can be saved, prior to being submitted to a validation process, by selecting a Save button 356. The information entered into the user interface 300 of the Mapping process can be reset by selecting a Reset button 358. The Mapping process can be cancelled by selecting a Cancel button 360.

Validation and Storage of Loss Data

As mentioned above, after loss transactions are collected and associated with loss events, the transaction and associated loss event information is submitted to a validation process. Business unit and/or operational risk management personnel may be responsible for validating operational loss data with the general ledger. (Validation should be distinguished from reconciliation, which can be thought of as requiring matching each general ledger transaction with a transaction in the loss database.) Validation can be thought of as requiring that the total amount of losses stored in the general ledger database equals the total amount of losses stored in the Mapping process and/or the loss database.

As previously mentioned, the Mapping process may be configured so as to require that transactions that are greater than or equal to a predefined threshold amount, e.g., $10,000, are associated with a loss event. The threshold amounts may vary based on the organization and/or business unit. A validation control table may be provided to establish the predefined threshold amounts. An exemplary validation control table is set forth below.

| Threshold | Description | Default value | Rules |
|---|---|---|---|
| Event Association | Transactions equal | $10,000 | Must be less |
| | to or greater than | | than or equal |
| | this amount must be | | to all other |
| | associated with a | | threshold |
| | new or existing | | values |
| | event. Transactions | | |
| | below this amount | | |
| | will be summarized | | |
| | when imported | | |
| | from GL. | | |
| Event approval | Events with | $10 billion | Greater than |
| | aggregate loss equal | | or equal to |
| | to or greater than | | event |
| | this amount require | | identification |
| | approval by a | | threshold |
| | second party. | | |
| Extended | Events with | $10,000 | Must be |
| information | aggregate loss equal | | greater than or |
| | to or greater than | | equal to event |
| | this amount will | | identification |
| | require entry of | | threshold |
| | Basel type and FRA | | |
| Issue/Action Plan | Events with | $1,000,000 | Must be |
| | aggregate loss equal | | greater than or |
| | to or greater than | | equal to event |
| | this amount will | | identification |
| | automatically | | threshold |
| | generate an Issue | | |
| | for which the | | |
| | responsible party | | |
| | must then create an | | |
| | Action Plan. | | |

The validation process may cause an error message to appear if one or more transactions that are greater than or equal to the predefined threshold amount are submitted, but that have not been associated with a loss event. Transactions less than the predefined threshold amount may be submitted without having been associated with a loss event. Transactions less than the predefined threshold amount, which may not be required to be associated with a loss event, may be summarized based on Account, Org/Bus Unit, Debit Total and Credit total for storage in the loss database. A Summary event may be created for such summarized transactions, and the Event Name and Description fields are automatically assigned values, and the Loss Event Type and Functional Risk Area fields are automatically assigned the value “No Information.”

The validation process may be configured so to require only basic event identification for an event that is associated with one or more transactions having a total amount that is less than a predefined threshold amount, e.g., $10,000. Basic event information may not include, for example, information about a Loss Event Type or Functional Risk Area. If however, an event is, or becomes, associated with one or more transactions having a total amount greater than (or equal to) a predefined threshold amount, the validation process may be configured to require extended event information for such an event. Extended event information may include Loss Event Type or Functional Risk Area information.

The validation process may require that a value be assigned to the Category field for all transactions greater than or equal to a predefined threshold amount. The process may further require that a value be assigned to the Event Name field for transactions that have a Category value other than “Event.” The validation process also may require that an event has actually been created for any value that has been entered in the Event ID field. The validation process may be configured so as to not require approval of events created during the Mapping process. If a transaction submitted to the validation process has been associated with a different event by another user, a message indicating the conflict may be displayed and the user may be provided the option of either submitting the non-conflicting transactions for validation and storage in the loss database, or returning to the user interface to the Mapping process so that the conflict may be resolved.

After categorized loss data has been validated by the validation process, the categorized loss data may be loaded into and stored in a loss database. The general ledger transactions that have been associated with particular loss events via the Mapping process are stored in the loss database in association with the those events.

Loss Event Data Structure

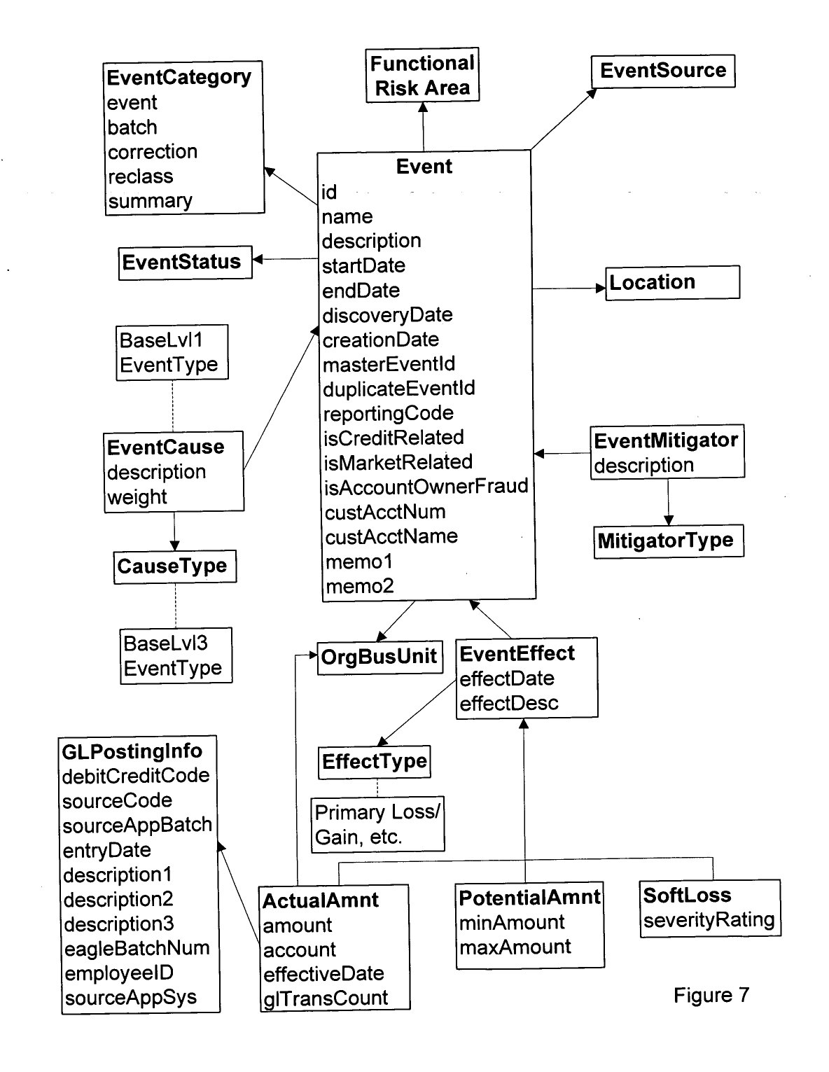

FIG. 7 illustrates an exemplary data structure for storing transactions representing operational losses in association with operational loss events. Such a data structure may be used to store in a loss database transactions representing operational losses that have been collected and associated with operational loss events via a Mapping process.

FIGS. 8A-8C illustrate exemplary file format for the data structure illustrated by FIG. 7. If the value in the Req column is 1, the corresponding data field is required for existing events, general ledger batches, corrections and reclassifications. If the value in the Req column is 2, the corresponding data field is required for new events. If the value in the Req column is 3, the corresponding data field is required for new events with aggregate amounts greater than (or equal to) a predefined threshold amount. If the value in the Req column is X, the corresponding data field is from the general ledger and may not be edited. If the value in the Req column is blank, the corresponding data field is optional.

While embodiments of the present invention have been described above, it is to be understood that any and all equivalent realizations of the present invention are included within the scope and spirit thereof. Thus, the embodiments depicted are presented by way of example only and are not intended as limitations upon the present invention. While particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

In addition, as mentioned above, the techniques described herein are not limited to any particular hardware or software configuration; they may find applicability in any computing or processing environment. The techniques may be implemented in hardware or software, or a combination of the two. Preferably, the techniques are implemented in computer programs and/or processes executing on programmable computers that each include a processor, a storage medium readable by the processor (including volatile and non-volatile memory and/or storage elements), at least one input device, and one or more output devices.

Each program or process is preferably implemented in high level procedural or object oriented programming language to communicate with a computer system. However, the programs can be implemented in assembly or machine language, if desired. In any case the language may be compiled or interpreted language.

Each such computer program is preferably stored on a storage medium or device (e.g., CD-ROM, hard disk, or magnetic disk) that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A computer-based method for managing operational risk by associating operational losses with one or more operational loss events, comprising:
specifying one or more general ledger transactions;
displaying one or more of the specified general ledger transactions;
associating one or more of the displayed general ledger transactions with operational loss information; and
storing the displayed general ledger transactions that have been associated with operational loss information in association with the operational loss information.

2. The method of claim 1, wherein the one or more general ledger transactions are specified by reference to a business unit.

3. The method of claim 1, wherein the one or more general ledger transactions are specified by reference to a transaction amount, a transaction date or an account code.

4. The method of claim 3, wherein the account code is associated with an account that is associated with an operational loss.

5. The method of claim 3, wherein the account code is a non-credit, operational loss account.

6. The method of claim 1, wherein the one or more general ledger transactions are specified by excluding general transactions that have been previously associated with an operational loss event.

7. The method of claim 1, wherein the one or more general ledger transactions are specified by excluding general transactions that have been previously associated with a predetermined source code.

8. The method of claim 7, wherein the predetermined source code is associated with an application that stores operational loss information.

9. The method of claim 8, wherein the application is selected from the group consisting of a legal case management application, a loss management application, a worker's compensation case management application and an insurance case management system.

10. The method of claim 1, further comprising:
establishing a loss data control table, wherein the one or more general ledger transactions are specified by reference to the loss data control table.

11. The method of claim 10, wherein the loss data control table establishes an event identification threshold for one or more business units, wherein each of the one or more general ledger transactions are specified if the amount of each of the one or more general transactions is equal to or greater than the event identification threshold.

12. The method of claim 10, wherein the loss data control table establishes an event identification threshold for one or more business units, wherein each of the one or more general ledger transactions are not specified if the amount of each of the one or more general transactions is less than the event identification threshold.

13. The method of claim 12, wherein the one or more general ledger transactions that are not specified are aggregated.

14. The method of claim 13, wherein the one or more general ledger transactions that are not specified are aggregated so as to allow for full operational loss reporting.

15. The method of claim 1, wherein the step of displaying the specified general ledger transactions is further comprised of displaying one or more of the following fields of information about the displayed general ledger transactions: a business unit, a general ledger account number, an amount, a date, and a description.

16. The method of claim 1, wherein the step of associating one or more of the displayed general ledger transactions with operational loss information is further comprised of associating one or more of the displayed general ledger transactions with one or more of the following fields of information: a loss amount category, a loss amount type, a loss event category, and a loss event type.

17. The method of claim 16, wherein the loss amount category field is assigned a value selected from the group consisting of actual amount, potential amount and soft loss.

18. The method of claim 17, wherein the loss amount type field for an actual amount is assigned a value selected from the group consisting of a loss/gain, an external cost, a cost recovery, a timing loss, an unposted loss or an estimate of a future loss.

19. The method of claim 18, wherein an external cost is selected from the group consisting of an attorneys fees, court costs, accountants fees, consultant fees and investigative fees.

20. The method of claim 18, wherein a cost recovery is selected from the group consisting of an insurance recovery, a customer recovery, a settlement, a judgment, a cost recovery and fraud recovery.

21. The method of claim 17, wherein the loss amount type field for a potential amount is assigned a value of estimate.

22. The method of claim 17, wherein an impact type field is associated with a soft loss, wherein the impact type field is assigned a value selected from the group consisting of reputation, customer and internal.

23. The method of claim 16, wherein the loss event category field is assigned a value selected from the group consisting of an operational loss event, a batch of operational losses, a summary of operational losses, a correction, a reclassification and a non-operational loss.

24. The method of claim 16, wherein the operational loss event type field is assigned a value selected from the group consisting of: internal fraud; external fraud; employment practices and workplace safety; clients, products and business practices; damage to physical assets; business disruption and system failures; and execution delivery and process management.

25. The method of claim 16, wherein the operational loss event type field is assigned a value selected from the group consisting of: unauthorized activity; theft and fraud; system security; employee relations; environment; diversity and discrimination; suitability, disclosure and fiduciary; improper business or market practices; product flaws; selection, sponsorship and exposure; advisory activities; disaster and other events; systems; transaction capture, execution and maintenance; customer intake and documentation; customer/client account management; trade counterparties; and vendors and suppliers.

26. The method of claim 16, wherein the operational loss event type field is assigned a value selected from the group consisting of Basel Event Level 1.

27. The method of claim 16, wherein the operational loss event type field is assigned a value selected from the group consisting of Basel Event Level 2.

28. The method of claim 16, wherein the operational loss event type field is assigned a value selected from the group consisting of Basel Event Level 3.

29. The method of claim 1, wherein the step of associating one or more of the displayed general ledger transactions with operational loss information is further comprised of associating one or more of the displayed general ledger transactions with a functional risk area.

30. The method of claim 29, wherein the functional risk area is selected from the group consisting of loss management, technology, human capital, business process, vendor, financial, real estate, fiduciary, legal, compliance, business continuity planning and change management.

31. The method of claim 1, wherein the step of associating one or more of the displayed general ledger transactions with operational loss information is further comprised of associating one or more of the displayed general ledger transactions with a business unit.

32. The method of claim 31, wherein the business unit is selected from the group consisting of capital management, general banking, corporate investment banking, wealth management, finance, human resources, technology, operations, ecommerce and other.

33. The method of claim 1, wherein the step of associating one or more of the displayed general ledger transactions with operational loss information is further comprised of associating the one or more of the displayed general ledger transactions with an operational loss event.

34. The method of claim 33, wherein an operational loss event is comprised of the following fields of information: a date of occurrence, a date of discovery, a description, an operational loss event type, a functional risk area, a business unit and an impact.

35. The method of claim 34, wherein the operational loss event type is selected from the group consisting of: internal fraud; external fraud; employment practices and workplace safety; clients, products and business practices; damage to physical assets; business disruption and system failures; and execution delivery and process management.

36. The method of claim 34, wherein the operational loss event type is selected from the group consisting of: unauthorized activity; theft and fraud; system security; employee relations; environment; diversity and discrimination; suitability, disclosure and fiduciary; improper business or market practices; product flaws; selection, sponsorship and exposure; advisory activities; disaster and other events; systems; transaction capture, execution and maintenance; customer intake and documentation; customer/client account management; trade counterparties; and vendors and suppliers.

37. The method of claim 34, wherein the functional risk area is selected from the group consisting of loss management, technology, human capital, business process, vendor, financial, real estate, fiduciary, legal, compliance, business continuity planning and change management.

38. The method of claim 34, wherein the business unit is selected from the group consisting of capital management, general banking, corporate investment banking, wealth management, finance, human resources, technology, operations, ecommerce and other.

39. The method of claim 34, wherein the impact is selected from the group consisting of a customer impact, a financial impact and a reputational impact.

40. The method of claim 1, further comprising:
validating the operational loss information prior to storing the displayed general ledger transactions that have been associated with operational loss information in association with the operational loss information.

41. The method of claim 40, wherein the step of validating the operational loss information is comprised of determining whether each of the one or more of the displayed general ledger transactions have been associated with operational loss information.

42. The method of claim 40, wherein the step of validating the operational loss information is comprised of determining whether each of the one or more of the displayed general ledger transactions have been associated with an operational loss event.

43. A computer readable medium containing a computer software for managing operational risk by associating operational losses with one or more operational loss events, the computer software comprising program instructions that:
specify one or more general ledger transactions;
display one or more of the specified general ledger transactions;
associate one or more of the displayed general ledger transactions with operational loss information; and
store the displayed general ledger transactions that have been associated with operational loss information in association with the operational loss information.

44. A computer based system for managing operational risk by associating operational losses with one or more operational loss events, comprising:
a processor configured to specify one or more general ledger transactions;
a display for displaying one or more of the specified general ledger transactions;
a user interface for associating one or more of the displayed general ledger transactions with operational loss information; and
a database for storing the displayed general ledger transactions that have been associated with operational loss information in association with the operational loss information.

45. A data structure configured to operate with a computer program for storing a transaction representing operational loss in association with operational loss event, the data structure comprising:
a first data element, wherein the first data element represents a transaction representing an operational loss;
a second data element, wherein the second data element represents an operational loss event;
wherein the first data element is stored in association with the second data element.

46. A user interface for associating one or more general ledger transactions with an operational loss event, comprising:
a first area for displaying one or more general ledger transactions, wherein each of the displayed general ledger transactions represent an operational loss;
a second area for associating one or more of the displayed general ledger transactions with an operational loss event.
